(19) United States
(12) Patent Application Publication
(10) Pub. No.: US 2026/0270773 A1
(43) Pub. Date: Sep. 10, 2026

(54) METHODS FOR SCHEDULING REQUEST AND BUFFER STATUS REPORTING

(71) Applicant: APPLE INC., Cupertino, CA (US)

(72) Inventors: Ping-Heng Kuo, London (GB); Haijing Hu, Los Gatos, CA (US); Alexander Sirotkin, Hod Hasharon (IL); Peng Cheng, Beijing (CN); Naveen Kumar R Palle Venkata, San Diego, CA (US); Ralf Rossbach, Munich (DE); Yuqin Chen, Beijing (CN); Fangli Xu, Beijing (CN); Zhibin Wu, Los Altos, CA (US); Sethuraman Gurumoorthy, San Ramon, CA (US)

(21) Appl. No.: 19/166,267

(22) PCT Filed: Apr. 5, 2023
(86) PCT No.: PCT/CN2023/086360

§ 371 Date: Sep. 17, 2025

(51) Int. Cl. H04W 28/02; H04W 74/0833

(52) U.S. Cl. CPC H04W 28/0278; H04W 74/0833

(57) ABSTRACT

A user equipment (UE) may store packet data unit (PDU) sets in a buffer memory. The UE may evaluate a buffer occupancy status of the PDU sets stored in the buffer memory. The UE may determine both the amount of data stored in the buffer memory and the PDU set importance (PSI) for the PDU sets. The UE may alter, based on the PSI parameters, a setting or a transmission occurrence of a random access (RA) procedure, a scheduling request (SR) for a buffer status report (BSR), or a BSR.

### TECHNICAL FIELD

This application relates generally to wireless communication systems, including scheduling request and buffer status report enhancements.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates two PDU sets that each include multiple data packets, in accordance with some embodiments.

FIG. 2 illustrates an aspect of the subject matter in accordance with one embodiment.

FIG. 3 illustrates a QoS flow that includes PDU sets with different importance levels in accordance with some embodiments.

FIG. 4 illustrates a signal flow diagram for transmitting a buffer status report in accordance with some embodiments.

FIG. 5 illustrates a flowchart of a method of a UE in accordance with some embodiments.

FIG. 6 illustrates a flowchart of a method of a UE in accordance with some embodiments.

FIG. 7 illustrates an example architecture of a wireless communication system, according to embodiments disclosed herein.

FIG. 8 illustrates a system for performing signaling between a wireless device and a network device, according to embodiments disclosed herein.

### DETAILED DESCRIPTION

Various embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Embodiments herein provide enhancements for scheduling requests as well as buffer status reports. In some embodiments, the enhancements relate to packet discarding. In some embodiments, the enhancements relate to packet data unit (PDU) set importance.

These enhancements may provide benefits to extended reality (XR) use cases. For example, the embodiments may support XR use cases more efficiently. XR is a term that refers immersive technologies such as augmented reality (AR), virtual reality (VR), and mixed reality (MR). The XR use cases typically feature lots of audio and video content. Wireless communication systems may employ strategies to handle such traffic that differ from conventional cellular traffic.

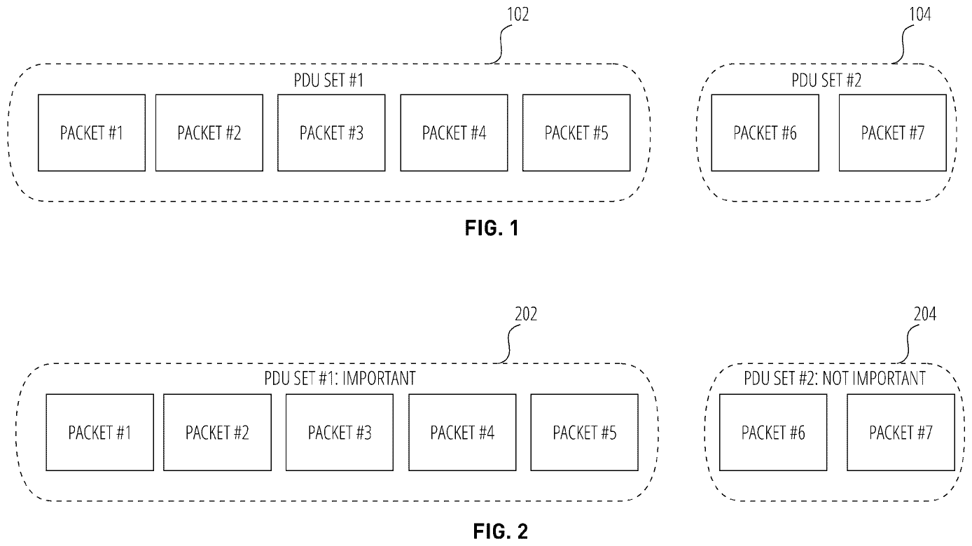

One difference between XR traffic and conventional cellular traffic is that XR services can use a PDU set comprising multiple packets. For example, FIG. 1 illustrates two PDU sets (i.e., first PDU set 102 and second PDU set 104) that each include multiple data packets. The packets may include data and may be formatted for different protocols. For example, the packets of the PDU sets may be internet protocol (IP) packets.

The PDU sets include data that XR services are attempting to send together. For example, a UE may receive the PDU sets from one or more XR services, store the PDU sets in an uplink buffer, and transmit the PDU sets from the uplink buffer to a network node when uplink resources are available. One PDU set may represent a data unit for an application. Accordingly, the packets in the PDU set may be treated all together from an application point of view. Lost packets may affect the PDU set as a whole. If some of the packets are lost, the PDU set may become useless from the application point of view.

Therefore, it is important for a wireless communication system to determine if XR PDU sets can be delivered successfully as a whole rather than treating the packets within the PDU sets individually as is done in conventional cellular communications. Accordingly, for XR use cases new quality of service (QoS) parameters have been defined for PDU sets. The new parameters apply to the PDU set as a whole rather than an individual packet.

The PDU Set Error Rate (PSER) defines an upper bound for the rate of PDU Sets that have been processed by the sender of a link layer protocol (e.g. Radio link control (RLC) in radio access network (RAN) of a 3GPP access) but that are not successfully delivered by the corresponding receiver to the upper layer (e.g. Packet data convergence protocol (PDCP) in RAN of a 3GPP access). Thus, the PSER defines an upper bound for a rate of non-congestion related packet losses. The purpose of the PSER is to allow for appropriate link layer protocol configurations (e.g. RLC and HARQ in RAN of a 3GPP access).

The PDU Set Delay Budget (PSDB) defines an upper bound for the delay that a PDU Set may experience for the transfer between the UE and the N6 termination point at the user plane function (UPF), i.e. the duration between the reception time of the first PDU (at the N6 termination point for downlink (DL) or the UE for uplink (UL)) and the delivery time of last PDU of a PDU Set. PSDB applies to the DL PDU Set received by the UPF over the N6 interface, and to the UL PDU Set sent by the UE.

The PDU Set Integrated Handling Indication (PSIHI) indicates whether all of the PDUs are needed for the usage of the PDU Set by the application layer in the receiver side. Some applications cannot tolerate any lost packets in a PDU set. Therefore, if one or more packets are lost these applications there is no point to transmit remaining packets since it would not be useful. Other applications do have some error correction techniques that any handle some lost packets.

Additionally, the following information may be provided on a per-PDU Set basis: PDU Set Sequence Number; end PDU of the PDU Set; PDU SN within a PDU Set; PDU Set Size in bytes; and PDU Set Importance (PSI). The PSI parameter is used to identify the importance of a PDU Set within a QoS flow. This implies in one traffic flow there may be PDU sets with different importance. RAN may use it for PDU Set level packet discarding in the presence of congestion.

In some cases, a network node or a UE may decide to drop a whole PDU set. Dropping the whole PDU set is referred to as discarding. PSIHI and PSI may be relevant to the decision to discard. With PSIHI and PSI, several PDU Set discarding mechanisms may be introduced in 3GPP.

When PSIHI is set to TRUE, the application layer may need every single packet within a PDU Set. Therefore, if one packet within a PDU Set is lost, then the whole PDU Set can be discarded (to e.g. save resource) because it is useless to the application. For example, when the PSIHI is set for a PDU set, as soon as one PDU is known to be lost, the remaining PDUs of that PDU Set can be considered as no longer needed by the application and may be subject to discard operation.

Further, for PDCP discard operation in uplink, the timer-based discard operation (when configured) should apply to all SDUs/PDUs belonging to the same PDU Set. Furthermore, when, for a PDU Set for which the PSIHI is set, one PDU is known to either be lost or associated to a discarded SDU, all remaining PDUs of that PDU Set could be discarded at the transmitter to free up radio resources.

The PSI may be used to determine if a PDU set should be discarded (or is more likely to be discarded) in cases of congestion. For example, PSI can be useful for PDU set-based discard. Mechanisms may allow a UE to handle discarding of packets with different PSI in case of congestion.

Based these mechanisms, packet discarding may happen much more frequently for XR use cases. Packet discarding may no longer be a rare situation. Some embodiments herein provide optimization in scheduling request (SR) and buffer status report (BSR) procedures by taking packet discarding into account.

FIG. 2 illustrates a QoS flow that includes PDU sets (i.e., important PDU set 202 and not important PDU set 204) with different importance levels. As shown, different PDU Sets within one QoS flow may have different PSIs.

Typically, PDU sets with different PSIs have the same treatment as they have the same QoS requirement. Since they are in the same QoS flow, they may be mapped to the same data radio bearers (DRB) (and eventually the same logical channel (LCH)).

However, in cases of congestion, the UE may be configured to handle the important PDU set 202 different than the not important PDU set 204. For instance, the UE may become more aggressive for transmission of important PDU sets, and/or become less aggressive for transmission of non-important PDU Sets. This is because it is more acceptable if non-important PDU Sets are discarded in cases of congestion.

For example, it has been proposed that PDCP discard timer value can be set to be different for important and non-important PDU sets, such that non-important PDU Sets are more easily or likely to get discarded compared to the important PDU sets. This is just one example of how the important PDU set 202 may be treated differently than the not important PDU set 204. Some embodiments herein describe different treatments to important and non-important PDU sets in cases of congestion. For instance, the important and non-important PDU sets may include differences in procedures of demanding resources (e.g. SR/BSR).

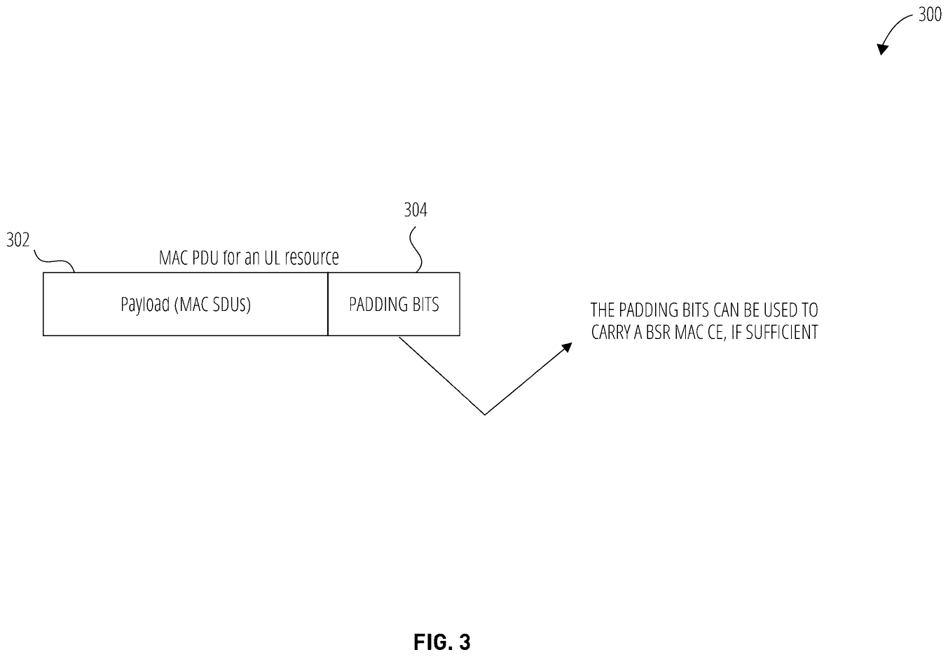

FIG. 3 illustrates a medium access control (MAC) PDU 300 for an uplink resource. As shown, the MAC PDU 300 includes a payload 302 and some padding bits 304. The payload 302 includes MAC service data units (SDUs). The padding bits 304 are any bits remaining that are not occupied by the payload 302. Accordingly, these padding bits 304 may be repurposed to include additional data.

BSR is an important mechanisms for a UE to inform the network node of how much uplink data has arrived in the buffer of the UE. Based on information received in the BSR, the network node is able to allocate uplink resource that can accommodate the buffered data.

BSR may be triggered when the padding bits 304 of an uplink resource is sufficient to carry a BSR MAC CE. When uplink resources are allocated and the number of padding bits is equal to or larger than the size of the Buffer Status Report MAC CE plus its subheader, the BSR may be referred below to as Padding BSR. The padding bits 304 can be used to carry a BSR MAC CE (e.g., padding BSR) if sufficient.

There are some issues that embodiments herein consider regarding PSI and Discarding. For example, the UE may initiate a Random Access (RA) procedure for a pending SR. However, packet discarding that results in an empty or lower buffer status may occur during or before the RA procedure, and the RA procedure may become unnecessary.

Further, SR and BSR procedures are controlled by several parameters such as an SR-Prohibit Timer and an SR-TransMax. To avoid frequent SR transmission in cases of congestion, it may not be necessary to use the same parameter setting for both important and non-important PDU Sets. Therefore, some embodiments herein describe using different parameter sets for important and non-important PDU sets.

Additionally, in 3GPP Release-18, a UE may be configured to trigger reporting of buffer delay information when the packet queueing time exceeds a threshold. To avoid frequent triggering of delay information reporting in cases of congestion, it may not be necessary to use the same packet queueing time threshold for both important and non-important PDU Sets. For example, the UE may trigger reporting more aggressively for important PDU sets.

Also, the UE may initiate a Random Access procedure when the number of SR transmissions reach SR-TransMax. However, in cases of congestion, whether this is needed may depend on if any important PDU Sets are in the buffer. Further, the UE may take the presence of an important PDU Set in the buffer into account when selecting a padding BSR format.

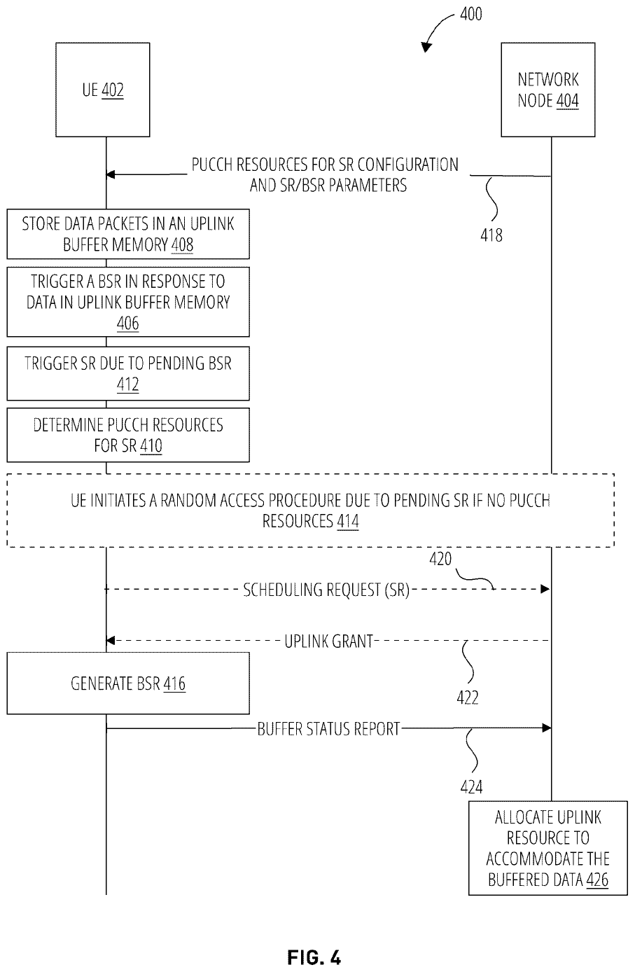

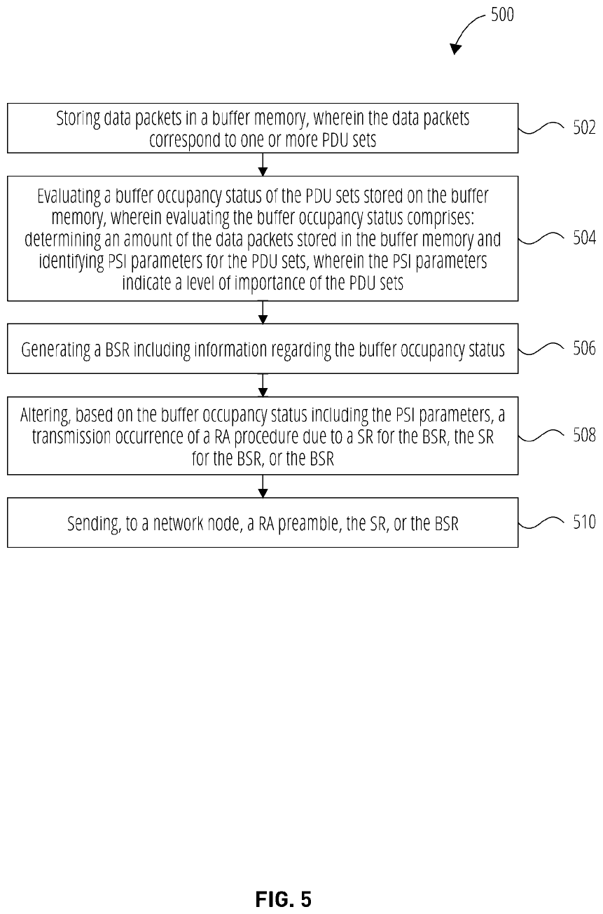

FIG. 4 illustrates a signal flow diagram 400 for transmitting a buffer status report, in accordance with some embodiments. As will be described, PSI and packet discarding may affect aspects of the scheduling request and buffer status procedure. The UE may use the PSI and the packet discarding to more efficiently use transmission resources. For example, in some embodiments, settings or transmission occurrences of random access procedures, scheduling requests, or buffer status procedure may be altered based on PSI and the packet discarding. In some embodiments, information within the BSR and a format of the BSR may be based on the availability of resources (e.g., padding bits or network congestion) and the PSI for the PDU sets in the buffer.

As shown, the network node 404 may send 418 PUCCH resources to the UE 402. In some embodiments, the network node 404 may also provide the UE 402 with SR and/or BSR parameters. The UE 402 stores 408 data packets for future uplink transmissions in an uplink buffer memory. The UE 402 triggers 406 a BSR when certain conditions are met relating to the data packets stored in the buffer.

The UE 402 triggers 412 a scheduling request due to the pending BSR. In response to the pending scheduling request, the UE 402 determines 410 whether there are valid PUCCH resources for transmission of the pending SR.

If the UE 402 has no valid PUCCH resources (e.g., UE resources are either not configured or released, or based on failed attempts to transmit scheduling request), then the UE 402 initiates 414 a random access procedure due to pending scheduling request. For example, once SR is triggered, the UE 402 may calculate the scheduling request periodicity and offset based on sr-ConfigIndex information element. After transmitting the first scheduling request, if the UE 402 doesn't receive uplink resources from the network node 404, then based on the periodicity, the UE 402 may re-send the scheduling request. This process continues until the UE 402 transmits the scheduling request for sr-TransMax number of times on PUCCH. After transmitting scheduling request for maximum (sr-TransMax) number of times, the UE 402 may release scheduling request resources and initiates the random access procedure.

The random access procedure may be used to establish a connection between the UE 402 and the network node 404. To initiate the random access procedure, the UE may send a random access preamble to the network node. After the random access procedure has successfully completed, the network node 404 may have allocated resources to the UE 402 for the BSR.

However, during or before the random access procedure, packet discarding of the data stored in the buffer may occur. To conserve resources, the UE 402 may monitor the packets stored in the buffer, and if certain conditions are met, the UE 402 may determine that the random access procedure is unnecessary and stop the random access procedure.

The UE 402 may stop random access procedure due to pending scheduling request in some conditions. For example, the UE 402 may stop, if any, ongoing random access procedure due to a pending scheduling request for BSR, which was initiated by the UE 402 prior to the MAC PDU assembly and which has no valid PUCCH resources, if a MAC PDU is transmitted using an uplink grant other than an uplink grant provided by random access response or an uplink grant determined for the transmission of the MSGA payload, and this PDU includes a BSR MAC CE which contains buffer status up to (and including) the last event that triggered a BSR prior to the MAC PDU assembly. The UE may also stop the random access procedure if the uplink grant(s) can accommodate all pending data available for transmission. The random access procedure can be stopped if all buffered data are transmitted or the corresponding BSR is transmitted.

In some embodiments, the UE 402 may stop the random access procedure based on the results of packet discarding. Packet discarding is much more likely to occur for XR use cases, and it is likely the UE 402 may discard all or a lot of data in the buffer at once (e.g. the whole PDU Set is dropped based on mechanisms for PSIHI or PSI). Accordingly, in some embodiments, the UE 402 may stop an ongoing random access procedure in cases of packet discarding.

Stopping the random access procure based on packet discarding may occur if a predefined condition is met. In some embodiments, the UE 402 may stop the random access procedure if all pending data of at least one logical channel (LCH) or logical channel group (LCG) are discarded. In some embodiments, the UE 402 may stop the random access procedure if the amount of discarded data of at least one LCH or LCG satisfies a threshold. For example, if the amount of discarded data is above a threshold, the random access procedure may be stopped. In some embodiments, the UE 402 may stop the random access procedure if the remaining data in the buffer after discarding satisfies a threshold. For example, if the amount of remaining data is below a threshold, the random access procedure may be stopped. In some embodiments, the UE 402 may stop the random access procedure if the remaining data in the buffer after discarding does not include any important PDU set. In some embodiments, the UE 402 may stop the random access procedure if the queueing delay of remaining data in the buffer after discarding satisfies a threshold.

Optionally, in some embodiments, allowing the UE 402 to stop the random access procedure based on packet discarding may only apply in cases of congestion. In some embodiments, the UE 402 can determine if congestion is present based on an explicit or implicit indication from the network. In some embodiments, the UE 402 can determine by itself whether congestion is present. For example, the UE 402 may determine congestion by checking the buffer status.

Further, stopping the random access procedure based on packet discarding may be restricted to the pending scheduling request triggered by specific LCHs and/or based on specific scheduling request configurations. The network node 404 can preconfigure which LCH(s) and/or which scheduling request configurations can lead to such behavior. The proposed behavior may be applicable to pending scheduling request for sidelink (SL) BSR.

As an example, the UE 402 may initiate a random access procedure due to a pending scheduling request. The UE 402 may discard, at least one data unit in an uplink buffer associating to the pending scheduling request. The UE 402 may evaluate, a status of the uplink buffer after the discarding, and determine, based on evaluating, if the random access procedure should be stopped. The UE 402 may determine that the random access procedure should be stopped if the conditions described herein occur.

If the UE 402 determines that PUCCH resources are configured, the UE sends 420 a scheduling request to the network node 404. The scheduling request is a message used by the UE 402 to request uplink resources from the network node 404. Those uplink resources may be used to transmit the BSR. The network node 404 sends 422 the UE 402 an uplink grant to provide approval for the UE 402 to transmit the BSR.

The UE generates 416 a BSR to inform the network node 404 about the data in the uplink buffer memory. The BSR is a MAC CE sent from the UE 402 to network node 404 carrying the information on how much data is in the UE uplink buffer. In some embodiments, the BSR may also include delay information. The UE 402 can report buffer delay information with an extended BSR or a new type of MAC CE. In some embodiments, the delay information may include the amount of time that data from one or more logical channels has been queueing or waiting in the buffer. In some embodiments, the delay information may include the amount of remaining time until the delivery deadline time of data buffered in one or more logical channels. In some embodiments, the delay information may include a binary flag indicating whether data from one or more logical channels are considered as urgent. This information can allow the network node 404 to perform some delay aware scheduling.

Reporting of the delay information may occur when a triggering condition is met. For example, reporting of buffer delay information can be triggered when the minimum or maximum queueing delay among packets in the buffer exceeds a threshold, or when the minimum or maximum remaining time until the delivery deadline among packets in the buffer is shorter than a threshold.

In some embodiments, these triggering conditions may be adaptive based on current conditions. For example, the UE 402 may adjust the triggering conditions based on importance of the PDU sets and/or network congestion. For example, to reduce the overhead of delay information reporting when the network is congested, some UE behaviors relating to delay information reporting may be altered in cases of congestions.

In cases of network congestion, some triggering conditions for delay information reporting can also take PDU set importance into account. The UE 402 may implement one or more of the following options to take PDU set importance into account during network congestion. In some embodiments, the UE 402 may only trigger delay information reporting of a LCH or logical channel group (LCG) if there is an important PDU set in the buffer. Otherwise, the UE does not trigger delay information reporting of the LCH/LCG. In some embodiments, the UE 402 may apply a different delay time threshold for triggering delay information reporting based on whether an important PDU Set is present in the buffer. For instance, a smaller delay time threshold may be used for triggering the delay information reporting when there is an important PDU set and a larger delay time threshold when there is not an important PDU set. In some embodiments, the UE 402 may trigger delay information reporting of a LCH or LCG as soon as an important PDU set arrives at the buffer. Otherwise, in such embodiments, the UE 402 follows a default triggering condition configured originally. In some embodiments, the UE 402 may only report the delay information corresponding to important PDU sets in the MAC CE, and does not take delay information of non-important PDU sets into account when generating the MAC CE. For example, if the UE 402 is configured to report delay information for a PDU set that has been in the buffer for the longest, the UE 402 may adapt and instead report delay information for the longest buffered important PDU set and not report delay information for a non-important PDU set even if that non-important PDU set has been in the buffer longer. Thus, the UE 402 may not report the delay information for the non-important PDU sets.

In some embodiments, the configuration of delay information reporting for one or more LCHs may be autonomously disabled when the network becomes congested. The network node 404 may pre-configure whether a LCH can disable delay information reporting in case of congestion. In some embodiments, the UE 402 may only apply the adaptive triggering conditions for delay information reporting in cases of congestion. In some embodiments, the UE 402 can determine if congestion is present based on an explicit/implicit indication from the network node 404. In some embodiments, the UE 402 can also determine by itself whether congestion is present. For example, the UE 402 may determine congestion by checking the buffer status.

The UE 402 sends the BSR 424 to the network node 404. The network node 404 can use the BSR report to allocate 426 uplink resource to accommodate the buffered data.

In some embodiments, the UE 402 may use adaptive SR and BSR parameters for the SR/BSR procedure. The SR/BSR parameters may be adapted based on the presence of important PDU sets in the buffer. The SR/BSR procedures are controlled by the following pre-configured RRC parameters: sr-ProhibitTimer (per SR configuration); sr-TransMax (per SR configuration); periodicBSR-Timer; retxBSR-Timer; logicalChannelSR-DelayTimer Applied; logicalChannelSR-DelayTimer; and logicalChannelSR-Mask.

The sr-ProhibitTimer parameter is a timer that prohibits the UE from sending the scheduling request while it is running. The sr-TransMax parameter defines a maximum transmission condition for the scheduling request. When the maximum number of SR requests are sent and the uplink grant cannot be obtained, the random access process is triggered by sending a PRACH preamble to obtain the uplink scheduling. The periodicBSR-Timer parameter is a timer that triggers a periodic BSR. The retxBSR-Timer parameter is a timer that when it expires and the UE has data available for transmission for any of the logical channels which belong to a LCG, a BSR is triggered. The logicalChannelSR-DelayTimerApplied parameter indicates whether to apply the delay timer for scheduling request transmission for a logical channel. The logicalChannelSR-DelayTimer parameter is used to delay the transmission of an SR for logical channels enabled by logicalChannelSR-Delay. The logicalChannelSR-Mask provides logical channel scheduling request masking.

In some embodiments, the UE 402 can adapt the value(s) of at least one of these parameters depend on if any important PDU Set is in the uplink buffer. For example, the UE 402 may use a shorter SR-prohibit Timer if there is an important PDU Set in the buffer, in order to signal the scheduling request more aggressively/frequently. Otherwise, a default value of SR-prohibit Timer with a longer time may be applied. In some embodiments, the network node 404 may configure two values for at least one of the SR/BSR parameters, and the UE 402 can choose the parameter value to use based on whether an important PDU set is present in the buffer.

In some embodiments, the UE 402 may select alternative PUCCH resources for scheduling request signaling based on whether an important PDU set is present in the buffer. For example, the network node 404 may provide the UE 402 with two PUCCH resources. The UE 402 may use a first set of PUCCH resources for the scheduling request when the buffer contains no important PDU sets. The UE 402 may switch to the alternative PUCCH resource for the scheduling request when an important PDU set is present in the buffer.

Occasionally, the buffer may not include an important PDU set until after a SR/BSR is already triggered. In cases where the important PDU set arrives at the buffer after the SR/BSR is already triggered by non-important PDU Sets, the UE 402 may stop at least one of SR-prohibit Timer, retxBSR Timer, and logicalChannelSR-delay Timer, if running. Therefore, the SR/BSR can be triggered immediately after arrival of important PDU Set. In some embodiments, when the important PDU set arrives at the buffer after the SR/BSR is already triggered, the UE 402 may reset the SR-Counter, so that the UE 402 can have more opportunities to signal the scheduling request for important PDU sets before initiating random access procedure. In some embodiments, when the important PDU set arrives at the buffer after the SR/BSR is already triggered, the UE 402 may initiate the random access procedure directly, without waiting until the number of scheduling request transmissions reaches sr-TransMax.

In some embodiments, the adaptive parameter behavior may be restricted to the pending scheduling request triggered by specific LCHs and/or based on specific scheduling restriction configurations. The network node 404 can preconfigure which LCH(s) and/or which scheduling restriction configurations can lead to such behavior. In some embodiments, the UE 402 may only apply the adaptive parameter behavior in cases of congestion. In some embodiments, the UE 402 can determine if congestion is present based on an explicit or implicit indication from the network. In some other embodiments, the UE 402 can also determine by itself whether congestion is present. For example, the UE 402 may determine congestion by checking the buffer status.

In some embodiments, initialization of the random access procedure may be based on whether an important PDU set is present in the buffer. Normally the UE 402 should initiate random access procedure if the number of SR transmission reaches sr-TransMax. However, in cases of congestion, the UE 402 can further check if there is any important PDU set in the buffer to determine if it should initiate the random access procedure. For example, in some embodiments, if there is at least one important PDU Set in the buffer, the UE 402 initiates the random access procedure when the value of SR_COUNTER reaches sr-TransMax, in order to get a grant in the random access response. Specific random access partition or random access prioritization may be used when the important PDU set is present in the buffer. Additionally, if none of the data in the buffer corresponds to an important PDU set (or if all data in the buffer correspond to non-important PDU Set), the UE 402 does not initiate the random access procedure when the value of SR_COUNTER reaches sr-TransMax in such embodiments.

Further, initialization of the random access procedure based on important PDU sets may be restricted to the pending scheduling request triggered by specific LCHs and/or based on specific scheduling request configurations. The network node 404 can preconfigure which LCH(s) and/or which scheduling request configurations can lead to such behavior.

In some instances, if there is room after a MAC PDU payload (e.g., in padding bits), the BSR may be sent using the padding bits. Some embodiments may provide enhancements to such padding BSRs. For example, in some embodiments, the UE 402 can report two (or more) buffer sizes for a LCH/LCG in one BSR MAC CE in order to provide buffer size level with finer granularity. The two buffer size levels include a first buffer size level (e.g. based on legacy BSR table) which used as a baseline buffer size, and a second buffer size level (e.g. based on a new BSR table) which is used as a differential buffer size. The two buffer sizes for a LCH/LCG included in the same MAC CE can be combined to provide a more accurate buffer size information (e.g. the first and second buffer size level can be summed up).

However, when dealing with padding BSR there is not always a set number of padding bits. Accordingly, a BSR format with multiple buffer sizes may not always fit in the padding bits. In some embodiments, the number of buffer size level to be included in a BSR may depend on the number of padding bits on a particular MAC PDU. For example, if there are at least two possible BSR formats the UE 402 can choose which to use based on the number of padding bits. The two possible formats may include a first BSR format with two (or more) buffer size levels for each of the at least one LCH/LCG, and a second BSR format with only one buffer size level for each of the at least one LCH/LCG (e.g. Legacy BSR format).

The UE 402 may check whether the number of padding bits of a MAC PDU is sufficient for a MAC CE BSR comprising two (or more) buffer size levels for each of the at least one LCH/LCG. If the number of padding bits is sufficient, the UE 402 may select the BSR format with two (or more) buffer size levels for each of the at least one LCH/LCG. Otherwise, if the number of padding bits is only sufficient for BSR formats with one buffer size level for at least one LCH/LCG, the UE 402 may select the BSR format that with only one buffer size for each of the at least one LCH/LCG.

Enhancements relating to padding BSR may take into account whether important PDU sets are in the buffer. For example, in some embodiments, the UE 402 may check whether the number of padding bits of a MAC PDU is sufficient for a MAC CE BSR comprising buffer size information for all LCH/LCGs with data available. If the number of padding bit is not sufficient, the UE 402 may prioritize buffer size levels for LCHs/LCGs that have important a PDU Set in the buffer, when generating the padding BSR MAC CE.

In some embodiments, the UE 402 may determine that the number of padding bits of a MAC PDU is sufficient for either one of the following BSR formats. A first format may be a BSR format for a first number of LCH/LCG, with finer granularity buffer size level and/or delay information. A second format may be a BSR format for a second number of LCH/LCGs, without finer granularity buffer size level and/or delay information. The second number is larger than the first number. The UE 402 may check if any LCH/LCG has important PDU Set available in the buffer. If so, the UE 402 may select the first BSR format for padding the BSR to report buffer status (with finer granularity and/or delay information) of at least one LCH/LCG that has important PDU Sets in the buffer. Otherwise, if none of the LCH/LCGs have important PDU sets in the buffer, the UE 402 may select the second BSR format for padding the BSR to report buffer status of multiple LCH/LCGs.

FIG. 5 illustrates a flowchart of a method 500 of a UE, according to embodiments herein. The method 500 includes storing 502, data packets in a buffer memory, wherein the data packets correspond to one or more PDU sets. The method 500 further includes evaluating 504 a buffer occupancy status of the PDU sets stored on the buffer memory, wherein evaluating the buffer occupancy status comprises: determining an amount of the data packets stored in the buffer memory and identifying PSI parameters for the PDU sets, wherein the PSI parameters indicate a level of importance of the PDU sets.

The method 500 further includes generating 506 a BSR including information regarding the buffer occupancy status. The method 500 further includes altering 508, based on the buffer occupancy status including the PSI parameters, a transmission occurrence of a RA procedure corresponding to a SR for the BSR, the SR for the BSR, or the BSR. The method 500 further includes sending 510, to a network node, a RA preamble, the SR, or the BSR.

In some embodiments, the method 500 further comprises: initiating, the RA procedure due to the SR, discarding, at least one of the data packets stored in the buffer memory, updating the buffer occupancy status after the discarding, and determining whether the buffer occupancy status has satisfied a target condition, wherein when the buffer occupancy status has satisfied the target condition the RA procedure is stopped, and wherein when the buffer occupancy status has not satisfied the target condition the RA procedure continues. In some such embodiments, the RA procedure is stopped when: all pending data are discarded, an amount of discarded data satisfies a first threshold, remaining data in the buffer memory after discarding satisfies a second threshold, the remaining data in the buffer memory after discarding does not include any important PDU set as indicated by the PSI parameters, or queueing delay of the remaining data in the buffer memory after discarding satisfies a third threshold.

In some embodiments of the method 500, altering the transmission occurrence comprises adapting values of one or more SR or BSR parameters if an important PDU set, as indicated by the PSI parameters, is in the buffer memory. Some such embodiments further comprise receiving, from a network node, two values for the one or more SR or BSR parameters, and selecting to use one of the two values based on a presence of the important PDU set in the buffer memory. Some such embodiments further comprise using a shorter SR-prohibit timer if the important PDU set is in the buffer memory. Some such embodiments further comprise selecting alternative PUCCH resources for the SR if the important PDU Set is in the buffer memory.

In some embodiments of the method 500, altering the transmission occurrence comprises: continuing to monitor the buffer memory after the SR is sent, and when an important PDU set arrives in the buffer memory, modifying one or more SR or BSR parameters to allow signaling of a second SR for the important PDU set to occur sooner than the SR or BSR parameters previously allowed.

In some embodiments, the method 500 further comprises: determining presence of network congestion, and refraining, due to the network congestion, from initiating the RA procedure when a value of SR_COUNTER reaches sr-TransMax. Some such embodiments further comprise canceling the SR.

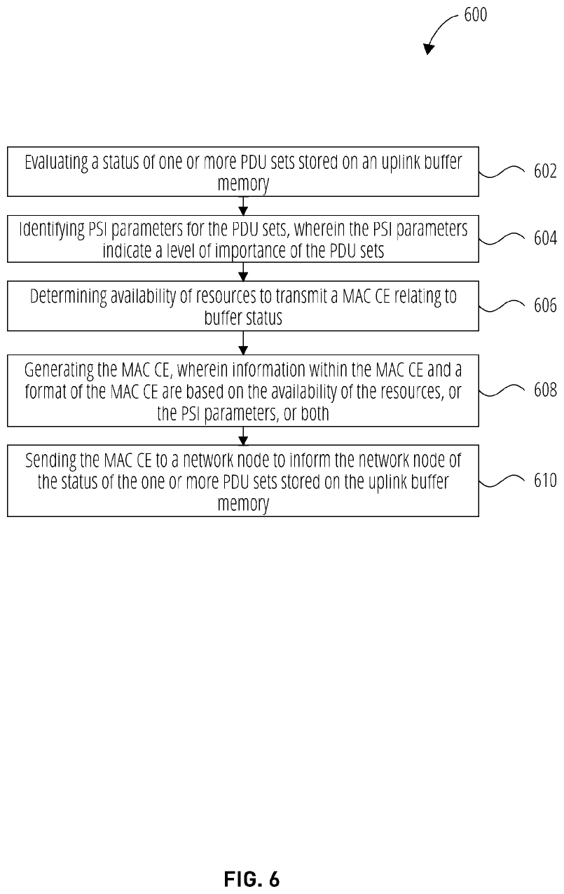

FIG. 6 illustrates a flowchart of a method 600 of a UE, according to embodiments herein. The method 600 includes evaluating 602 a status of one or more PDU sets stored on an uplink buffer memory. The method 600 further includes identifying 604 PSI parameters for the PDU sets, wherein the PSI parameters indicate a level of importance of the PDU sets. The method 600 further includes determining 606 availability of resources to transmit a MAC CE relating to buffer status.

The method 600 further includes generating 608 the MAC CE, wherein information within the MAC CE and a format of the MAC CE are based on the availability of the resources, or the PSI parameters, or both. The method 600 further includes sending 610 the MAC CE to a network node to inform the network node of the status of the one or more PDU sets stored on the uplink buffer memory.

In some embodiments of the method 600, determining the availability of the resources comprises determining when the network is congested, wherein when the network is congested, the MAC CE comprises buffer delay information when there is an important PDU set as indicated by the PSI parameters in the uplink buffer memory.

In some embodiments, the method 600 further comprises, applying a first delay time threshold for triggering buffer delay information reporting when an important PDU set is in the uplink buffer memory, and applying a second delay time threshold for triggering the buffer delay information reporting when no important PDU sets are in the uplink buffer memory.

In some embodiments, the method 600 further comprises, triggering delay information reporting when an important PDU set arrives at the uplink buffer memory. In some embodiments of the method 600, the MAC CE comprises delay information corresponding to important PDU sets.

In some embodiments of the method 600, determining the availability of the resources comprises checking whether a number of padding bits of a medium access control (MAC) PDU is sufficient for a MAC CE format with multiple buffer size levels per logical channel or per logical channel group for the BSR, wherein if the number of padding bits is sufficient, the MAC CE format with multiple buffer size levels per logical channel or per logical channel group is selected for padding of the MAC PDU of the BSR includes the multiple buffer size levels, and wherein if the number of padding bits is insufficient, the MAC CE format of the BSR with only one buffer size level per logical channel or per logical channel group is selected for padding of the MAC PDU includes one buffer size level.

In some embodiments of the method 600, determining the availability of the resources comprises: checking whether a number of padding bits of a MAC PDU is sufficient for buffer size information for all logical channels and logical channel groups with data available, wherein if the number of padding bits is not sufficient, generating the MAC CE comprising prioritizing buffer size levels for the logical channels and the logical channel groups that have an important PDU set in the uplink buffer memory.

In some embodiments of the method 600, determining the availability of the resources comprises: determining that a number of padding bits of a MAC PDU is sufficient for either: a first MAC CE format for a first number of logical channels and logical channel groups, with finer granularity buffer size level and delay information, and a second MAC CE format for a second number of the logical channels and the logical channel groups, without finer granularity buffer size level and delay information, and checking if any of the logical channels and the logical channel groups have important PDU sets available in the uplink buffer memory, wherein if any of the logical channels and the logical channel groups have the important PDU sets, the first MAC CE format is selected for the MAC CE, and wherein if none of the logical channels and the logical channel groups have the important PDU sets, the second MAC CE format is selected for the MAC CE.

In some embodiments of the method 600, the MAC CE is a BSR.

In some embodiments, the UE may evaluate a status of one or more PDU sets stored on an uplink buffer memory. The UE may determine availability of resources to transmit a MAC CE relating to buffer status by checking whether a number of padding bits of MAC PDU is sufficient for a MAC CE format with multiple buffer size levels per logical channel or per logical channel group. If the number of padding bits is sufficient, the MAC CE format with multiple buffer size levels per logical channel or per logical channel group is selected for padding of the MAC PDU. If the number of padding bits is insufficient, the MAC CE format with only one buffer size level per logical channel or per logical channel group is selected for padding of the MAC PDU. The UE may send the MAC CE via the padding bits to a network node to inform the network node of the status of the one or more PDU sets stored on the uplink buffer memory.

In some embodiments, a UE may storing data packets in a buffer memory. The UE may evaluate a buffer occupancy status of the data packets stored on the buffer memory. The UE may initiate a random access (RA) procedure due to a pending scheduling request (SR) for a buffer status report (BSR) based on the buffer occupancy status. The UE may discard, before or during the RA procedure, at least one of the data packets stored in the buffer memory. The UE may update the buffer occupancy status after the discarding. The UE may determine whether to stop the RA procedure based on updates to the buffer occupancy status, wherein the RA procedure is stopped when: all pending data in the buffer memory are discarded, an amount of discarded data satisfies a first threshold, remaining data in the buffer memory after discarding satisfies a second threshold, the remaining data in the buffer memory after discarding does not include any important PDU set as indicated by the PSI parameters, or queueing delay of the remaining data in the buffer memory after discarding satisfies a third threshold. In some embodiments, the data packets correspond to one or more PDU Sets. In some embodiments, the buffer memory corresponds to a buffer of at least one more LCH or LCG.

Embodiments contemplated herein include an apparatus comprising means to perform one or more elements of methods 500 and 600. This apparatus may be, for example, an apparatus of a UE (such as a wireless device 802 that is a UE, as described herein).

Embodiments contemplated herein include one or more non-transitory computer-readable media comprising instructions to cause an electronic device, upon execution of the instructions by one or more processors of the electronic device, to perform one or more elements of methods 500 and 600. This non-transitory computer-readable media may be, for example, a memory of a UE (such as a memory 806 of a wireless device 802 that is a UE, as described herein).

Embodiments contemplated herein include an apparatus comprising logic, modules, or circuitry to perform one or more elements of methods 500 and 600. This apparatus may be, for example, an apparatus of a UE (such as a wireless device 802 that is a UE, as described herein).

Embodiments contemplated herein include an apparatus comprising: one or more processors and one or more computer-readable media comprising instructions that, when executed by the one or more processors, cause the one or more processors to perform one or more elements of methods 500 and 600. This apparatus may be, for example, an apparatus of a UE (such as a wireless device 802 that is a UE, as described herein).

Embodiments contemplated herein include a signal as described in or related to one or more elements of the methods 500 and 600.

Embodiments contemplated herein include a computer program or computer program product comprising instructions, wherein execution of the program by a processor is to cause the processor to carry out one or more elements of the methods 500 and 600. The processor may be a processor of a UE (such as a processor(s) 604 of a wireless device 802 that is a UE, as described herein). These instructions may be, for example, located in the processor and/or on a memory of the UE (such as a memory 806 of a wireless device 802 that is a UE, as described herein).

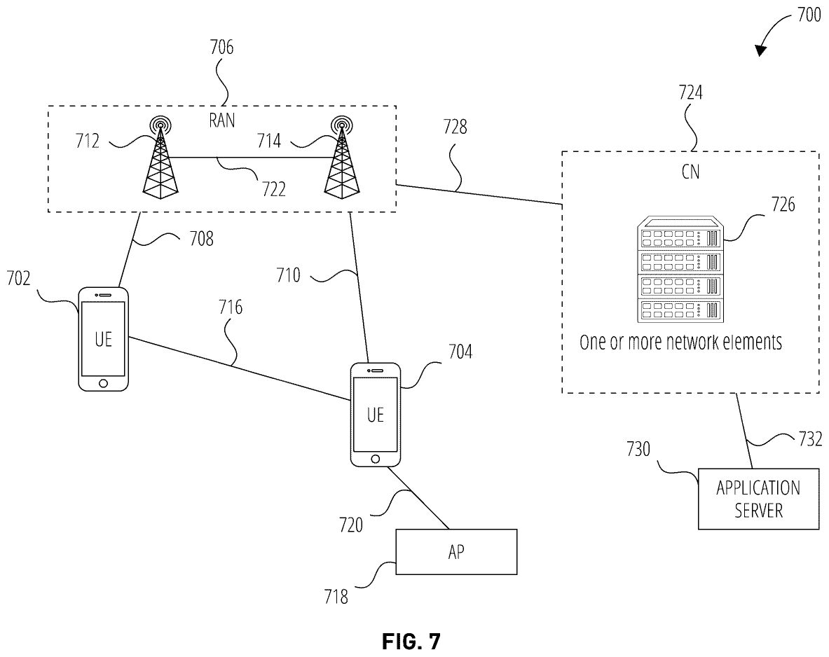

FIG. 7 illustrates an example architecture of a wireless communication system 700, according to embodiments disclosed herein. The following description is provided for an example wireless communication system 700 that operates in conjunction with the LTE system standards and/or 5G or NR system standards as provided by 3GPP technical specifications.

As shown by FIG. 7, the wireless communication system 700 includes UE 702 and UE 704 (although any number of UEs may be used). In this example, the UE 702 and the UE 704 are illustrated as smartphones (e.g., handheld touchscreen mobile computing devices connectable to one or more cellular networks), but may also comprise any mobile or non-mobile computing device configured for wireless communication.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more base stations (such as base station 712 and base station 714) that enable the connection 708 and connection 710.

In this example, the connection 708 and connection 710 are air interfaces to enable such communicative coupling, and may be consistent with RAT(s) used by the RAN 706, such as, for example, an LTE and/or NR.

In some embodiments, the UE 702 and UE 704 may also directly exchange communication data via a sidelink interface 716. The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-Fi® router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other or with the base station 712 and/or the base station 714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 712 or base station 714 may be implemented as one or more software entities running on server computers as part of a virtual network. In addition, or in other embodiments, the base station 712 or base station 714 may be configured to communicate with one another via interface 722. In embodiments where the wireless communication system 700 is an LTE system (e.g., when the CN 724 is an EPC), the interface 722 may be an X2 interface. The X2 interface may be defined between two or more base stations (e.g., two or more eNBs and the like) that connect to an EPC, and/or between two eNBs connecting to the EPC. In embodiments where the wireless communication system 700 is an NR system (e.g., when CN 724 is a 5GC), the interface 722 may be an Xn interface. The Xn interface is defined between two or more base stations (e.g., two or more gNBs and the like) that connect to 5GC, between a base station 712 (e.g., a gNB) connecting to 5GC and an eNB, and/or between two eNBs connecting to 5GC (e.g., CN 724).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

In embodiments, the CN 724 may be an EPC, and the RAN 706 may be connected with the CN 724 via an S1 interface 728. In embodiments, the S1 interface 728 may be split into two parts, an S1 user plane (S1-U) interface, which carries traffic data between the base station 712 or base station 714 and a serving gateway (S-GW), and the S1-MME interface, which is a signaling interface between the base station 712 or base station 714 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the base station 712 or base station 714 and a user plane function (UPF), and the S1 control plane (NG-C) interface, which is a signaling interface between the base station 712 or base station 714 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VoIP sessions, group communication sessions, etc.) for the UE 702 and UE 704 via the CN 724. The application server 730 may communicate with the CN 724 through an IP communications interface 732.

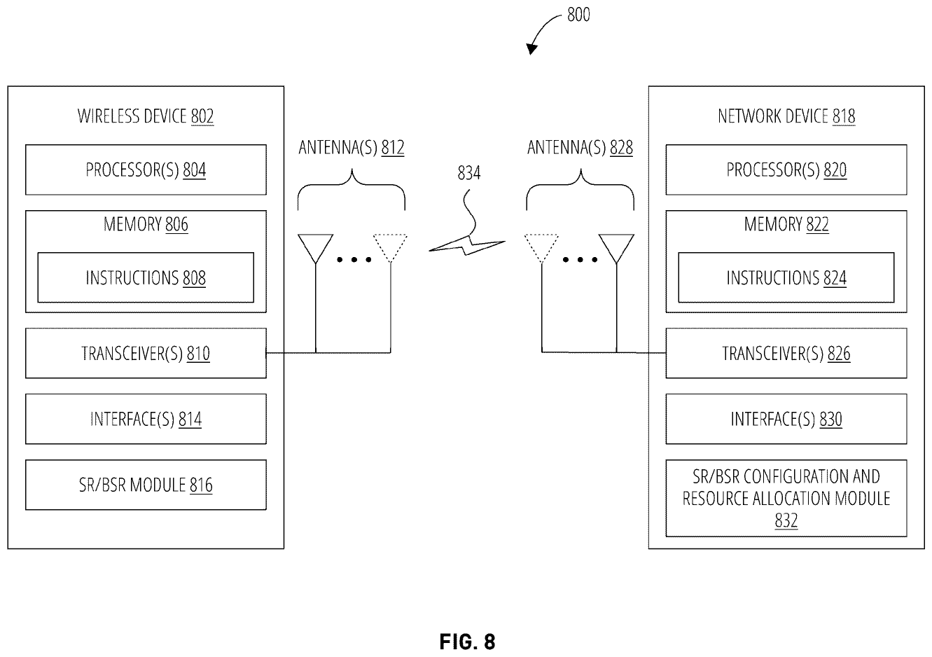

FIG. 8 illustrates a system 800 for performing signaling 834 between a wireless device 802 and a network device 818, according to embodiments disclosed herein. The system 800 may be a portion of a wireless communications system as herein described. The wireless device 802 may be, for example, a UE of a wireless communication system. The network device 818 may be, for example, a base station (e.g., an eNB or a gNB) of a wireless communication system.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include radio frequency (RF) transmitter circuitry and/or receiver circuitry that use the antenna(s) 812 of the wireless device 802 to facilitate signaling (e.g., the signaling 834) to and/or from the wireless device 802 with other devices (e.g., the network device 818) according to corresponding RATs.

The wireless device 802 may include one or more antenna(s) 812 (e.g., one, two, four, or more). For embodiments with multiple antenna(s) 812, the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 810/antenna(s) 812 already described) that allow for communication between the UE and other devices and may operate according to known protocols (e.g., Wi-Fi®, Bluetooth®, and the like).

The wireless device 802 may include an SR/BSR module 816. The SR/BSR module 816 may be implemented via hardware, software, or combinations thereof. For example, the SR/BSR module 816 may be implemented as a processor, circuit, and/or instructions 808 stored in the memory 806 and executed by the processor(s) 804. In some examples, the SR/BSR module 816 may be integrated within the processor(s) 804 and/or the transceiver(s) 810. For example, the SR/BSR module 816 may be implemented by a combination of software components (e.g., executed by a DSP or a general processor) and hardware components (e.g., logic gates and circuitry) within the processor(s) 804 or the transceiver(s) 810.

The SR/BSR module 816 may be used for various aspects of the present disclosure, for example, aspects of FIGS. 4-6. The SR/BSR module 816 is configured to execute random access procedures, scheduling request procedures, and buffer status report procedures as described herein.

The network device 818 may include one or more processor(s) 820. The processor(s) 820 may execute instructions such that various operations of the network device 818 are performed, as described herein. The processor(s) 820 may include one or more baseband processors implemented using, for example, a CPU, a DSP, an ASIC, a controller, an FPGA device, another hardware device, a firmware device, or any combination thereof configured to perform the operations described herein.

The network device 818 may include a memory 822. The memory 822 may be a non-transitory computer-readable storage medium that stores instructions 824 (which may include, for example, the instructions being executed by the processor(s) 820). The instructions 824 may also be referred to as program code or a computer program. The memory 822 may also store data used by, and results computed by, the processor(s) 820.

The network device 818 may include one or more transceiver(s) 826 that may include RF transmitter circuitry and/or receiver circuitry that use the antenna(s) 828 of the network device 818 to facilitate signaling (e.g., the signaling 834) to and/or from the network device 818 with other devices (e.g., the wireless device 802) according to corresponding RATs.

The network device 818 may include one or more antenna(s) 828 (e.g., one, two, four, or more). In embodiments having multiple antenna(s) 828, the network device 818 may perform MIMO, digital beamforming, analog beamforming, beam steering, etc., as has been described.

The network device 818 may include one or more interface(s) 830. The interface(s) 830 may be used to provide input to or output from the network device 818. For example, a network device 818 that is a base station may include interface(s) 830 made up of transmitters, receivers, and other circuitry (e.g., other than the transceiver(s) 826/antenna(s) 828 already described) that enables the base station to communicate with other equipment in a core network, and/or that enables the base station to communicate with external networks, computers, databases, and the like for purposes of operations, administration, and maintenance of the base station or other equipment operably connected thereto.

The network device 818 may include an SR/BSR configuration and resource allocation module 832. The SR/BSR configuration and resource allocation module 832 may be implemented via hardware, software, or combinations thereof. For example, the SR/BSR configuration and resource allocation module 832 may be implemented as a processor, circuit, and/or instructions 824 stored in the memory 822 and executed by the processor(s) 820. In some examples, the SR/BSR configuration and resource allocation module 832 may be integrated within the processor(s) 820 and/or the transceiver(s) 826. For example, the SR/BSR configuration and resource allocation module 832 may be implemented by a combination of software components (e.g., executed by a DSP or a general processor) and hardware components (e.g., logic gates and circuitry) within the processor(s) 820 or the transceiver(s) 826.

The SR/BSR configuration and resource allocation module 832 may be used for various aspects of the present disclosure, for example, aspects of FIG. 4. The SR/BSR configuration and resource allocation module 832 is configured to provide SR/BSR parameters and allocate uplink resources based on a buffer status report.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE), the method comprising:
storing data packets in a buffer memory, wherein the data packets correspond to one or more packet data unit (PDU) sets,
evaluating a buffer occupancy status of the PDU sets stored on the buffer memory, wherein evaluating the buffer occupancy status comprises:
determining an amount of the data packets stored in the buffer memory, and
identifying PDU set importance (PSI) parameters for the PDU sets, wherein the PSI parameters indicate a level of importance of the PDU sets;
generating a buffer status report (BSR) including information regarding the buffer occupancy status;
altering, based on the buffer occupancy status including the PSI parameters, a setting or a transmission occurrence of a random access (RA) procedure corresponding to a scheduling request (SR) for the BSR, the SR for the BSR, or the BSR; and
sending, to a network node, a RA preamble, the SR, or the BSR.

2. The method of claim 1, further comprising:
initiating, the RA procedure due to the SR;
discarding, at least one of the data packets stored in the buffer memory;
updating the buffer occupancy status after the discarding; and
determining whether the buffer occupancy status has satisfied a target condition,
wherein when the buffer occupancy status has satisfied the target condition the RA procedure is stopped, and
wherein when the buffer occupancy status has not satisfied the target condition the RA procedure continues.

3. The method of claim 2, wherein the RA procedure is stopped when:
all pending data are discarded,
an amount of discarded data satisfies a first threshold,
remaining data in the buffer memory after discarding satisfies a second threshold,
the remaining data in the buffer memory after discarding does not include any important PDU set as indicated by the PSI parameters, or
queueing delay of the remaining data in the buffer memory after discarding satisfies a third threshold.

4. The method of claim 1, wherein altering the setting or the transmission occurrence comprises adapting values of one or more SR or BSR parameters if an important PDU set, as indicated by the PSI parameters, is in the buffer memory.

5. The method of claim 4, further comprising receiving, from the network node, two values for the one or more SR or BSR parameters, and selecting to use one of the two values based on a presence of the important PDU set in the buffer memory.

6. The method of claim 4, further comprising using a shorter SR-prohibit timer if the important PDU set is in the buffer memory.

7. The method of claim 4, further comprising selecting alternative physical uplink control channel (PUCCH) resources for the SR if the important PDU Set is in the buffer memory.

8. The method of claim 1, wherein altering the setting or the transmission occurrence comprises:
continuing to monitor the buffer memory after the SR is sent, and
when an important PDU set arrives in the buffer memory, modifying one or more SR or BSR parameters to allow signaling of a second SR for the important PDU set to occur sooner than the SR or BSR parameters previously allowed.

9. The method of claim 1, further comprising:
determining presence of network congestion, and
refraining, due to the network congestion, from initiating the RA procedure when a value of SR_COUNTER reaches sr-TransMax.

10. The method of claim 9, further comprising canceling the SR.

11. A user equipment (UE) comprising:
a processor; and
a memory storing instructions that, when executed by the processor, configure the UE to:
store data packets in a buffer memory, wherein the data packets correspond to one or more packet data unit (PDU) sets,
evaluate a buffer occupancy status of the PDU sets stored on the buffer memory, wherein evaluating the buffer occupancy status comprises:
determining an amount of the data packets stored in the buffer memory, and
identifying PDU set importance (PSI) parameters for the PDU sets, wherein the PSI parameters indicate a level of importance of the PDU sets;
generate a buffer status report (BSR) including information regarding the buffer occupancy status;
alter, based on the buffer occupancy status including the PSI parameters, a setting or a transmission occurrence of a random access (RA) procedure corresponding to a scheduling request (SR) for the BSR, the SR for the BSR, or the BSR; and
send, to a network node, a RA preamble, the SR, or the BSR.

12. The UE of claim 11, wherein the instructions further configure the UE to:
initiate, the RA procedure due to the SR;
discard, at least one of the data packets stored in the buffer memory;
update the buffer occupancy status after the discarding; and
determine whether the buffer occupancy status has satisfied a target condition,
wherein when the buffer occupancy status has satisfied the target condition the RA procedure is stopped, and
wherein when the buffer occupancy status has not satisfied the target condition the RA procedure continues.

13. The UE of claim 12, wherein the RA procedure is stopped when:
all pending data are discarded,
an amount of discarded data satisfies a first threshold,
remaining data in the buffer memory after discarding satisfies a second threshold,
the remaining data in the buffer memory after discarding does not include any important PDU set as indicated by the PSI parameters, or
queue delay of the remaining data in the buffer memory after discarding satisfies a third threshold.

14. The UE of claim 11, wherein altering the setting or the transmission occurrence comprises adapting values of one or more SR or BSR parameters if an important PDU set, as indicated by the PSI parameters, is in the buffer memory.

15. The UE of claim 14, wherein the instructions further configure the UE to receive, from the network node, two values for the one or more SR or BSR parameters, and select to use one of the two values based on a presence of the important PDU set in the buffer memory.

16. The UE of claim 14, wherein the instructions further configure the UE to use a shorter SR-prohibit timer if the important PDU set is in the buffer memory.

17. The UE of claim 14, wherein the instructions further configure the UE to select alternative physical uplink control channel (PUCCH) resources for the SR if the important PDU Set is in the buffer memory.

18. The UE of claim 11, wherein altering the setting or the transmission occurrence comprises:
continuing to monitor the buffer memory after the SR is sent, and
when an important PDU set arrives in the buffer memory, modifying one or more SR or BSR parameters to allow signaling of a second SR for the important PDU set to occur sooner than the SR or BSR parameters previously allowed.

19. The UE of claim 11, wherein the instructions further configure the UE to:
determine presence of network congestion, and
refrain, due to the network congestion, from initiating the RA procedure when a value of SR_COUNTER reaches sr-TransMax.

20. The UE of claim 19, wherein the instructions further configure the UE to cancel the SR.

21-33. (canceled)
